(19) United States
(12) Patent Application Publication
(10) Pub. No.: US 2003/0149028 A1
(43) Pub. Date: Aug. 7, 2003

(54) Pesticidal compositions

(76) Inventors: Juriy Grigorievich Shermolovich, Kiev (UA); Uwe Doller, Rodgau (DE); Sergiy Vasiliovich Yemets, Kiev (UA); Maria-Theresia Thonessen, Heidesheim (DE); Waltraud Hempel, Liederbach (DE)

Correspondence Address: Eric H. Weisblatt, Esquire, BURNS, DOANE, SWECKER & MATHIS, L.L.P., P.O. Box 1404, Alexandria, VA, 22313-1404, US

(21) Appl. No.: 10/238,603

(22) Filed: Sep. 11, 2002

(30) Foreign Application Priority Data
Sep. 13, 2001 (EP) 01121965.6

(51) Int. Cl. A01N 43/84

(52) U.S. Cl. 514/223.8; 514/224.2

(57) ABSTRACT

The invention relates to a compound which is a 4-spirocyclic pyrazole of formula (I):

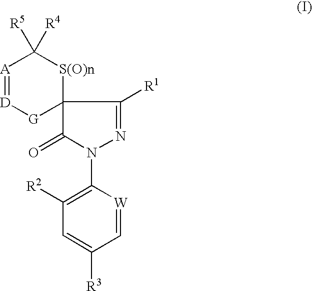

wherein the various symbols are as defined in the description; to compositions containing them, processes and intermediates for their preparation and a method of controlling arthropod pests and nematodes by means of such compositions.

The invention relates to 4-spirocyclic pyrazole compounds, compositions containing them, processes for their preparation, and their use for the control of arthropod pests (including insects and endo- and ecto-parasites) and nematodes.

In Chem. Het. Comp. 36 (2000) 152 sulfur-containing spirocyclic compounds based on 3-methyl-(amino)-1-phynylpyrazol-5-ones are disclosed, however, no utility is stated for the synthesized compounds.

It has now been found that 4-spirocyclic pyrazoles are useful as pesticides.

Accordingly, the present invention provides a compound of formula (I):

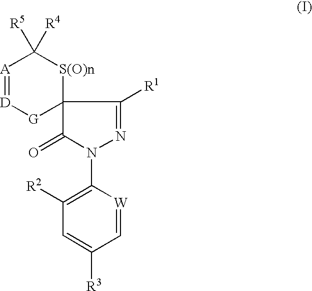

wherein:

R¹ is alkyl, haloalkyl, NH₂, CN, CSNH₂, NO₂ or halogen;

W is N or CR⁶;

R² and R⁶ are each independently hydrogen or halogen;

R³ is hydrogen, halogen, haloalkyl (preferably CF₃), haloalkoxy (preferably OCF₃), —S(O)ₚCF₃ or SF₅;

A is CR⁷ or N;

D is CR⁸ or N;

G is CR⁹R¹⁰, O, S(O)_{q} or NR¹¹;

R⁴, R⁷, R⁸ and R⁹ are each the same or different hydrogen, alkyl, haloalkyl, alkenyl, haloalkenyl, alkynyl, cycloalkyl, halogen, alkoxy, haloalkoxy, CO₂H, CO₂R¹², CHO, COR¹², CN, OH, OCOR¹³, OSiR¹²R¹⁴R¹⁵, OP(═O)(OR¹²)(OR¹⁴); alkyl substituted by OH, alkoxy or CO₂R¹²; NR¹⁶R¹⁷, NHCOR¹², NHCO₂R¹³, SiR¹²R¹⁴R¹⁵, S(O)ₘR¹², S(O)ᵤR¹³, R¹³ or R¹⁸;

or any two adjacent groups R⁴, R⁵, R⁷, R⁸, R⁹ and R¹⁰ may together with the atoms to which they are attached form a monocyclic, or fused bicyclic ring system, each ring of which is a 4 to 7 membered saturated, partially or fully unsaturated carbocycle or heterocycle, said heterocycle containing from 1 to 3 heteroatoms which may be the same or different selected from O, N and S, which rings may also contain a bridging group X, and each ring being optionally substituted by alkyl, halogen or alkoxy which may be the same or different;

or when G is CR⁹R¹⁰, R⁴ and R⁹ may together form a bridging group X;

X is O, S(O)ᵣ or —(CH₂)ₜNR¹⁹, —(CR²⁰R²¹)ₛ—, —C(═O)O— or —C(═O)NR²²—;

R⁵ and R¹⁰ are each the same or different hydrogen, alkyl, halogen, alkoxy or CO₂R;

R¹¹, R²⁰ and R²¹ are each the same or different hydrogen or alkyl;

R¹², R¹⁴ and R¹⁵ are each the same or different alkyl or haloalkyl;

R¹³ is phenyl optionally substituted by halogen, alkyl, haloalkyl, alkoxy, CN, NO₂ or NR¹⁶R¹⁷;

R¹⁶ and R¹⁷ are each the same or different hydrogen, alkyl or haloalkyl;

R¹⁸ is a three to seven membered heterocyclic ring containing one or more O, N or S atoms, which may be staurated, partially or fully unsaturated, which is optionally substituted by halogen, alkyl, haloalkyl, alkoxy, CN, NO₂ or NR¹⁶R¹⁷;

R¹⁹ and R²² are each the same or different hydrogen, alkyl, COR¹² or CO₂R¹²;

m, n, p, q, r and u are each independently have the values zero, one or two;

s is one, two or three; and

t is zero or one;

with the provisos:

i) when D is N, G is not O, S(O)_{q} or NR¹¹;

ii) when R² is H, R³ is H, R⁴ is H, R⁵ is H, W is CH, A is C(methyl), D is C(methyl), G is CH₂, and n is 0, 1 or 2, then R¹ is not methyl;

iii) when R¹ is amino, R² is H, R³ is H, R⁴ is H, R⁵ is H, W is CH, A is C(methyl), D is C(methyl), G is CH₂, then n is not 0; and

iv) when R² is H, R³ is H, R⁵ is H, W is CH, A is CH, D is CH, G is CR⁹R¹⁰, R¹⁰ is H, R⁴ and R⁹ together form a bridging group —CH₂—, and n is 0, then R¹ is not methyl;

or an agriculturally acceptable salt thereof.

The 4-spirocyclic pyrazoles and the agriculturally acceptable salts thereof as defined above, possess valuable pesticidal properties.

The invention also encompasses any stereoisomer, enantiomer or geometric isomer, and mixtures thereof.

By the term “agriculturally acceptable salts” is meant salts the cations or anions of which are known and accepted in the art for the formation of salts for agricultural or horticultural use. Suitable salts with bases include alkali metal (e.g. sodium and potassium), alkaline earth metals (e.g. calcium and magnesium), ammonium and amine (e.g. diethanolamine, triethanolamine, octylamine, morpholine and dioctylmethylamine) salts. Suitable acid addition salts, e.g. formed by compounds of formula I containing an amino group, include salts with inorganic acids, for example hydrochlorides, sulphates, phosphates and nitrates and salts with organic acids for example acetic acid.

Unless otherwise specified alkyl and alkoxy groups (or portions thereof) may be straight- or branched-chain and have from one to ten (preferably one to six) carbon atoms.

Cycloalkyl groups have from three to six carbon atoms in the ring and may be substituted by alkyl or halogen.

Alkenyl groups may be straight- or branched-chain and have from two to six (preferably two to four) carbon atoms.

The term “halo” before the name of a radical means that this radical is partially or completely halogenated, that is to say, substituted by F, Cl, Br, or 1, in any combination, preferably by F or Cl. The term “halogen” means F, Cl, Br or 1.

Preferably R¹ is alkyl, NH₂ or CN (more preferably R¹ is CN).

Preferably R² is hydrogen or halogen (more preferably R² is halogen).

Preferably W is CR⁶ wherein R⁶ is hydrogen or halogen (more preferably W is CR⁶ wherein R⁶ is halogen).

Preferably R³ is hydrogen, haloalkyl or haloalkoxy (more preferably R³ is CF₃ or OCF₃).

Preferably R⁴ and R⁵ are each the same or different hydrogen, alkyl or phenyl.

Preferably A is CR⁷ wherein R⁷ is hydrogen, alkyl or phenyl.

Preferably D is CR⁸ wherein R⁸ is hydrogen, alkyl or phenyl.

Preferably G is CR⁹R¹⁰ wherein R⁹ is hydrogen, alkyl or phenyl, or OSiR¹²R¹⁴R¹⁵, and R¹⁰ is hydrogen; or when G is CR⁹R¹⁰, R⁴ and R⁹ may together form a bridging group X, wherein X is O or —(CH₂)ₛ— wherein s is 1 or 2.

A preferred class of compounds of formula (I) are those in which:

R¹ is R¹ is alkyl, NH₂ or CN;

R² is hydrogen or halogen (halogen is more preferred);

W is CR⁶ wherein R⁶ is hydrogen or halogen;

R³ is hydrogen, haloalkyl or haloalkoxy;

R⁴ and R⁵ are each the same or different hydrogen, alkyl or phenyl;

A is CR⁷ wherein R⁷ is hydrogen, alkyl or phenyl;

D is CR⁸ wherein R⁸ is hydrogen, alkyl or phenyl; and

G is CR⁹R¹⁰ wherein R⁹ is hydrogen, alkyl or phenyl, or OSiR¹²R¹⁴R¹⁵, and R¹⁰ is hydrogen; or when G is CR⁹R¹⁰, R⁴ and R⁹ may together form a bridging group X, wherein X is —(CH₂)ₛ— wherein s is 1 or 2.

A further preferred class of compounds of formula (I) are those in which:

R¹ is CN; R² is halogen (more preferably R² is chlorine); W is CR⁶ wherein R⁶ is halogen (more preferably R⁶ is chlorine); and R³ is CF₃.

Particularly preferred compounds of the invention include:

(3-amino-1-phenylpyrazolin-5-one)-4-spiro-2′-(4′,5′-dimethyl-2′H-3′,6′-dihydrothiane);

[1-(2,6-dichloro-4-trifluoromethylphenyl)-3-methylpyrazolin-5-one]-4-spiro-2′-(5′-phenyl-2′H-3′,6′-dihydrothiane);[1-(2,6-dichloro-4-trifluoromethylphenyl)-3-methylpyrazolin-5-one]-4-spiro-2′-(3′-trimethylsilyloxy-2′H-3′,6′-dihydrothiane);[1-(2,6-dichloro-4-trifluoromethylphenyl)-3-methylpyrazolin-5-one]-4-spiro-2′-(4′,5′-dimethyl-2′H-3′,6′-dihydrothiane;

[3-amino-1-(2,6-dichloro-4-trifluoromethylphenyl)pyrazolin-5-one]-4-spiro-2′-(4′,5′-dimethyl-2′H-3′,6′-dihydrothiane);

[3-amino-1-(2,6-dichloro-4-trifluoromethylphenyl)pyrazolin-5-one]-4-spiro-3′-(2′-thiabicyclo[2.2.1]hept-5′-ene);

[1-(2,6-dichloro-4-trifluoromethylphenyl)-3-methylpyrazolin-5-one]-4-spiro-3′-(2′-thiabicyclo[2.2.1]hept-5′-ene);

[1-(2,6-dichloro-4-trifluoromethylphenyl)-3-cyanopyrazolin-5-one]-4-spiro-2′-(4′,5′-dimethyl-2′H-3′,6′-dihydrothiane);

[1-(2,6-dichloro-4-trifluoromethylphenyl)-3-methylpyrazolin-5-one]-4-spiro-2′-(5′-phenyl-1′-oxo-2′H-3′,6′-dihydrothiane);

[1-(2,6-dichloro-4-trifluoromethylphenyl)-3-methylpyrazolin-5-one]-4-spiro-2′-(4′,5′-dimethyl-1′-oxo-2′H-3′,6′-dihydrothiane);

[1-(2,6-dichloro-4-trifluoromethylphenyl)-3-methylpyrazolin-5-one]-4-spiro-2′-(5′-phenyl-1′,1′-dioxo-2′H-3′,6′-dihydrothiane);

[1-(2,6-dichloro-4-trifluoromethylphenyl)-3-methylpyrazolin-5-one]-4-spiro-2′-(4′,5′-dimethyl-1′,1′-dioxo-2′H-3′,6′-dihydrothiane);

[1-(2,6-dichloro-4-trifluoromethylphenyl)-3-cyanopyrazolin-5-one]-4-spiro-2′-(5′-phenyl-2′H-3′,6′-dihydrothiane); [1-(2,6-dichloro-4-trifluoromethylphenyl)-3-cyanopyrazolin-5-one]-4-spiro-2′-(4′,5′-dimethyl-1′,1′-dioxo-2′H-3′,6′-dihydrothiane);

[1-(2,6-dichloro-4-trifluoromethylphenyl)-3-cyanopyrazolin-5-one]-4-spiro-2′-(4′,5′-dimethyl-1′-oxo-2′H-3′,6′-dihydrothiane); [1-(2,6-dichloro-4-trifluoromethylphenyl)-3-methylpyrazolin-5-one]-4-spiro-2′-(6′-phenyl-2′H-3′,6′-dihydrothiane) and [1-(2,6-dichloro-4-trifluoromethylphenyl)-3-methylpyrazolin-5-one]-4-spiro-2′-(3′-phenyl-2′H-3′,6′-dihydrothiane); and [1-(2,6-dichloro-4-trifluoromethylphenyl)-3-methylpyrazolin-5-one]-4-spiro-2′-(6′-methyl-2′H-3′,6′-dihydrothiane) and [1-(2,6-dichloro-4-trifluoromethylphenyl)-3-methylpyrazolin-5-one]-4-spiro-2′-(3′-methyl-2′H-3′,6′-dihydrothiane).

The following compounds of formula (Ia) below and shown in Table 1 also form part of the present invention.

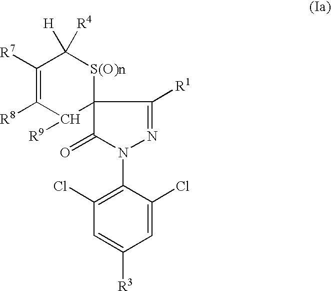

In the tables below ‘Ph’ means phenyl and ‘Me’ means methyl. Where subscripts are omitted after atoms it will be understood that they are intended, for example CF3 means CF₃.

TABLE 1

| Compound | | | | | | | |
|---|---|---|---|---|---|---|---|
| No | R¹ | n | R³ | R⁴ | R⁷ | R⁸ | R⁹ |
| 3 | Me | 0 | CF₃ | H | Ph | H | H |
| 4 | Me | 0 | CF₃ | H | H | H | OSiMe₃ |
| 5 | Me | 0 | CF₃ | H | Me | Me | H |
| 6 | NH₂ | 0 | CF₃ | H | Me | Me | H |
| 9 | CN | 0 | CF₃ | H | Me | Me | H |
| 12 | Me | 1 | CF₃ | H | Ph | H | H |
| 13 | Me | 1 | CF₃ | H | Me | Me | H |
| 15 | Me | 2 | CF₃ | H | Ph | H | H |
| 16 | Me | 2 | CF₃ | H | Me | Me | H |
| 17 | CN | 0 | CF₃ | H | H | H | H |
| 18 | CN | 2 | CF₃ | H | Me | Me | H |
| 19 | CN | 1 | CF₃ | H | Me | Me | H |
| 20 | Me | 0 | CF₃ | H | H | H | Ph (a) |
| 21 | Me | 0 | CF₃ | H | H | H | Me (b) |
| 22 | CN | 1 | CF₃ | H | H | H | H |
| 23 | CN | 2 | CF₃ | H | H | H | H |
| 24 | CN | 0 | CF₃ | Me | H | H | H |
| 25 | CN | 1 | CF₃ | Me | H | H | H |
| 26 | CN | 2 | CF₃ | Me | H | H | H |
| 27 | CN | 0 | CF₃ | Me | H | H | Me |
| 28 | CN | 1 | CF₃ | Me | H | H | Me |
| 29 | CN | 2 | CF₃ | Me | H | H | Me |
| 30 | CN | 0 | CF₃ | H | H | H | Me |
| 31 | CN | 1 | CF₃ | H | H | H | Me |
| 32 | CN | 2 | CF₃ | H | H | H | Me |
| 33 | CN | 0 | CF₃ | H | Me | H | H |
| 34 | CN | 1 | CF₃ | H | Me | H | H |
| 35 | CN | 2 | CF₃ | H | Me | H | H |
| 36 | CN | 0 | CF₃ | Ph | H | H | H |
| 37 | CN | 1 | CF₃ | Ph | H | H | H |
| 38 | CN | 2 | CF₃ | Ph | H | H | H |
| 39 | CN | 0 | CF₃ | H | Ph | H | H |
| 40 | CN | 1 | CF₃ | H | Ph | H | H |
| 41 | CN | 2 | CF₃ | H | Ph | H | H |
| 42 | CN | 0 | CF₃ | H | H | Ph | H |
| 43 | CN | 1 | CF₃ | H | H | Ph | H |
| 44 | CN | 2 | CF₃ | H | H | Ph | H |
| 45 | CN | 0 | CF₃ | H | H | H | Ph |
| 46 | CN | 1 | CF₃ | H | H | H | Ph |
| 47 | CN | 2 | CF₃ | H | H | H | Ph |
| 48 | Me | 0 | OCF₃ | H | Ph | H | H |
| 49 | Me | 0 | OCF₃ | H | H | H | OSiMe₃ |
| 50 | Me | 0 | OCF₃ | H | Me | Me | H |
| 51 | NH₂ | 0 | OCF₃ | H | Me | Me | H |
| 52 | CN | 0 | OCF₃ | H | Me | Me | H |
| 53 | Me | 1 | OCF₃ | H | Ph | H | H |
| 54 | Me | 1 | OCF₃ | H | Me | Me | H |
| 55 | Me | 2 | OCF₃ | H | Ph | H | H |
| 56 | Me | 2 | OCF₃ | H | Me | Me | H |
| 57 | CN | 0 | OCF₃ | H | H | H | H |
| 58 | CN | 2 | OCF₃ | H | Me | Me | H |
| 59 | CN | 1 | OCF₃ | H | Me | Me | H |
| 60 | Me | 0 | OCF₃ | H | H | H | Ph |
| 61 | Me | 0 | OCF₃ | H | H | H | Me |
| 62 | CN | 1 | OCF₃ | H | H | H | H |
| 63 | CN | 2 | OCF₃ | H | H | H | H |
| 64 | CN | 0 | OCF₃ | Me | H | H | H |
| 65 | CN | 1 | OCF₃ | Me | H | H | H |
| 66 | CN | 2 | OCF₃ | Me | H | H | H |
| 67 | CN | 0 | OCF₃ | Me | H | H | Me |
| 68 | CN | 1 | OCF₃ | Me | H | H | Me |
| 69 | CN | 2 | OCF₃ | Me | H | H | Me |
| 70 | CN | 0 | OCF₃ | H | H | H | Me |
| 71 | CN | 1 | OCF₃ | H | H | H | Me |
| 72 | CN | 2 | OCF₃ | H | H | H | Me |
| 73 | CN | 0 | OCF₃ | H | Me | H | H |
| 74 | CN | 1 | OCF₃ | H | Me | H | H |
| 75 | CN | 2 | OCF₃ | H | Me | H | H |
| 76 | CN | 0 | OCF₃ | Ph | H | H | H |
| 77 | CN | 1 | OCF₃ | Ph | H | H | H |
| 78 | CN | 2 | OCF₃ | Ph | H | H | H |
| 79 | CN | 0 | OCF₃ | H | Ph | H | H |
| 80 | CN | 1 | OCF₃ | H | Ph | H | H |
| 81 | CN | 2 | OCF₃ | H | Ph | H | H |
| 82 | CN | 0 | OCF₃ | H | H | Ph | H |
| 83 | CN | 1 | OCF₃ | H | H | Ph | H |
| 84 | CN | 2 | OCF₃ | H | H | Ph | H |
| 85 | CN | 0 | OCF₃ | H | H | H | Ph |
| 86 | CN | 1 | OCF₃ | H | H | H | Ph |
| 87 | CN | 2 | OCF₃ | H | H | H | Ph |

Note: (a) Compound number 20 comprises a mixture with the corresponding compound in which to R⁴ is phenyl and R⁹ is H;
(b) compound number 21 comprises a mixture with the corresponding compound in which to R⁴ is methyl and R⁹ is H.

The following compounds of formula (Ib) below and shown in Table 2 also form part of the present invention.

TABLE 2

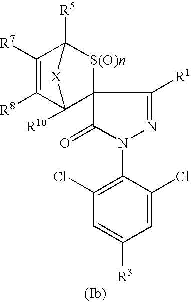

| Compound No | R¹ | n | R³ | R⁵ | R⁷ | R⁸ | R¹⁰ | X |
|---|---|---|---|---|---|---|---|---|
| 7 | NH₂ | 0 | CF₃ | H | H | H | H | CH₂ |
| 8 | Me | 0 | CF₃ | H | H | H | H | CH₂ |
| 88 | CN | 0 | CF₃ | H | H | H | H | CH₂ |
| 89 | CN | 1 | CF₃ | H | H | H | H | CH₂ |
| 90 | CN | 2 | CF₃ | H | H | H | H | CH₂ |
| 91 | CN | 0 | CF₃ | Me | H | H | H | CH₂ |
| 92 | CN | 1 | CF₃ | Me | H | H | H | CH₂ |
| 93 | CN | 2 | CF₃ | Me | H | H | H | CH₂ |
| 94 | CN | 0 | CF₃ | H | Me | H | H | CH₂ |
| 95 | CN | 1 | CF₃ | H | Me | H | H | CH₂ |
| 96 | CN | 2 | CF₃ | H | Me | H | H | CH₂ |
| 97 | CN | 0 | CF₃ | H | H | Me | H | CH₂ |
| 98 | CN | 1 | CF₃ | H | H | Me | H | CH₂ |
| 99 | CN | 2 | OCF₃ | H | H | Me | H | CH₂ |
| 100 | CN | 0 | CF₃ | H | H | H | Me | CH₂ |
| 101 | CN | 1 | CF₃ | H | H | H | Me | CH₂ |
| 102 | CN | 2 | CF₃ | H | H | H | Me | CH₂ |
| 103 | CN | 0 | CF₃ | Ph | H | H | H | CH₂ |
| 104 | CN | 1 | CF₃ | Ph | H | H | H | CH₂ |
| 105 | CN | 2 | CF₃ | Ph | H | H | H | CH₂ |
| 106 | CN | 0 | CF₃ | H | Ph | H | H | CH₂ |
| 107 | CN | 1 | CF₃ | H | Ph | H | H | CH₂ |
| 108 | CN | 2 | CF₃ | H | Ph | H | H | CH₂ |
| 109 | CN | 0 | CF₃ | H | H | Ph | H | CH₂ |
| 110 | CN | 1 | CF₃ | H | H | Ph | H | CH₂ |
| 111 | CN | 2 | CF₃ | H | H | Ph | H | CH₂ |
| 112 | CN | 0 | CF₃ | H | H | H | Ph | CH₂ |
| 113 | CN | 1 | CF₃ | H | H | H | Ph | CH₂ |
| 114 | CN | 2 | CF₃ | H | H | H | Ph | CH₂ |
| 115 | CN | 0 | OCF₃ | H | H | H | H | CH₂ |
| 116 | CN | 1 | OCF₃ | H | H | H | H | CH₂ |
| 117 | CN | 2 | OCF₃ | H | H | H | H | CH₂ |
| 118 | CN | 0 | OCF₃ | Me | H | H | H | CH₂ |
| 119 | CN | 1 | OCF₃ | Me | H | H | H | CH₂ |
| 120 | CN | 2 | OCF₃ | Me | H | H | H | CH₂ |
| 121 | CN | 0 | OCF₃ | H | Me | H | H | CH₂ |
| 122 | CN | 1 | OCF₃ | H | Me | H | H | CH₂ |
| 123 | CN | 2 | OCF₃ | H | Me | H | H | CH₂ |
| 124 | CN | 0 | OCF₃ | H | H | Me | H | CH₂ |
| 125 | CN | 1 | OCF₃ | H | H | Me | H | CH₂ |
| 126 | CN | 2 | OCF₃ | H | H | Me | H | CH₂ |
| 127 | CN | 0 | OCF₃ | H | H | H | Me | CH₂ |
| 128 | CN | 1 | OCF₃ | H | H | H | Me | CH₂ |
| 129 | CN | 2 | OCF₃ | H | H | H | Me | CH₂ |
| 130 | CN | 0 | OCF₃ | Ph | H | H | H | CH₂ |
| 131 | CN | 1 | OCF₃ | Ph | H | H | H | CH₂ |
| 132 | CN | 2 | OCF₃ | Ph | H | H | H | CH₂ |
| 133 | CN | 0 | OCF₃ | H | Ph | H | H | CH₂ |
| 134 | CN | 1 | OCF₃ | H | Ph | H | H | CH₂ |
| 135 | CN | 2 | OCF₃ | H | Ph | H | H | CH₂ |
| 136 | CN | 0 | OCF₃ | H | H | Ph | H | CH₂ |
| 137 | CN | 1 | OCF₃ | H | H | Ph | H | CH₂ |
| 138 | CN | 2 | OCF₃ | H | H | Ph | H | CH₂ |
| 139 | CN | 0 | OCF₃ | H | H | H | Ph | CH₂ |
| 140 | CN | 1 | OCF₃ | H | H | H | Ph | CH₂ |
| 141 | CN | 2 | OCF₃ | H | H | H | Ph | CH₂ |
| 142 | CN | 0 | CF₃ | H | H | H | H | CH₂CH₂ |
| 143 | CN | 1 | CF₃ | H | H | H | H | CH₂CH₂ |
| 144 | CN | 2 | CF₃ | H | H | H | H | CH₂CH₂ |
| 145 | CN | 0 | CF₃ | Me | H | H | H | CH₂CH₂ |
| 146 | CN | 1 | CF₃ | Me | H | H | H | CH₂CH₂ |
| 147 | CN | 2 | CF₃ | Me | H | H | H | CH₂CH₂ |
| 148 | CN | 0 | CF₃ | H | Me | H | H | CH₂CH₂ |
| 149 | CN | 1 | CF₃ | H | Me | H | H | CH₂CH₂ |
| 150 | CN | 2 | CF₃ | H | Me | H | H | CH₂CH₂ |
| 151 | CN | 0 | CF₃ | H | H | Me | H | CH₂CH₂ |
| 152 | CN | 1 | CF₃ | H | H | Me | H | CH₂CH₂ |
| 153 | CN | 2 | CF₃ | H | H | Me | H | CH₂CH₂ |
| 154 | CN | 0 | CF₃ | H | H | H | Me | CH₂CH₂ |
| 155 | CN | 1 | CF₃ | H | H | H | Me | CH₂CH₂ |
| 156 | CN | 2 | CF₃ | H | H | H | Me | CH₂CH₂ |
| 157 | CN | 0 | CF₃ | Ph | H | H | H | CH₂CH₂ |
| 158 | CN | 1 | CF₃ | Ph | H | H | H | CH₂CH₂ |
| 159 | CN | 2 | CF₃ | Ph | H | H | H | CH₂CH₂ |
| 160 | CN | 0 | CF₃ | H | Ph | H | H | CH₂CH₂ |
| 161 | CN | 1 | CF₃ | H | Ph | H | H | CH₂CH₂ |
| 162 | CN | 2 | CF₃ | H | Ph | H | H | CH₂CH₂ |
| 163 | CN | 0 | CF₃ | H | H | Ph | H | CH₂CH₂ |
| 164 | CN | 1 | CF₃ | H | H | Ph | H | CH₂CH₂ |
| 165 | CN | 2 | CF₃ | H | H | Ph | H | CH₂CH₂ |
| 166 | CN | 0 | CF₃ | H | H | H | Ph | CH₂CH₂ |
| 167 | CN | 1 | CF₃ | H | H | H | Ph | CH₂CH₂ |
| 168 | CN | 2 | CF₃ | H | H | H | Ph | CH₂CH₂ |
| 169 | CN | 0 | OCF₃ | H | H | H | H | CH₂CH₂ |
| 170 | CN | 1 | OCF₃ | H | H | H | H | CH₂CH₂ |
| 171 | CN | 2 | OCF₃ | H | H | H | H | CH₂CH₂ |
| 172 | CN | 0 | OCF₃ | Me | H | H | H | CH₂CH₂ |
| 173 | CN | 1 | OCF₃ | Me | H | H | H | CH₂CH₂ |
| 174 | CN | 2 | OCF₃ | Me | H | H | H | CH₂CH₂ |
| 175 | CN | 0 | OCF₃ | H | Me | H | H | CH₂CH₂ |
| 176 | CN | 1 | OCF₃ | H | Me | H | H | CH₂CH₂ |
| 177 | CN | 2 | OCF₃ | H | Me | H | H | CH₂CH₂ |
| 178 | CN | 0 | OCF₃ | H | H | Me | H | CH₂CH₂ |
| 179 | CN | 1 | OCF₃ | H | H | Me | H | CH₂CH₂ |
| 180 | CN | 2 | OCF₃ | H | H | Me | H | CH₂CH₂ |
| 181 | CN | 0 | OCF₃ | H | H | H | Me | CH₂CH₂ |
| 182 | CN | 1 | OCF₃ | H | H | H | Me | CH₂CH₂ |
| 183 | CN | 2 | OCF₃ | H | H | H | Me | CH₂CH₂ |
| 184 | CN | 0 | OCF₃ | Ph | H | H | H | CH₂CH₂ |
| 185 | CN | 1 | OCF₃ | Ph | H | H | H | CH₂CH₂ |
| 186 | CN | 2 | OCF₃ | Ph | H | H | H | CH₂CH₂ |
| 187 | CN | 0 | OCF₃ | H | Ph | H | H | CH₂CH₂ |
| 188 | CN | 1 | OCF₃ | H | Ph | H | H | CH₂CH₂ |
| 189 | CN | 2 | OCF₃ | H | Ph | H | H | CH₂CH₂ |
| 190 | CN | 0 | OCF₃ | H | H | Ph | H | CH₂CH₂ |
| 191 | CN | 1 | OCF₃ | H | H | Ph | H | CH₂CH₂ |
| 192 | CN | 2 | OCF₃ | H | H | Ph | H | CH₂CH₂ |
| 193 | CN | 0 | OCF₃ | H | H | H | Ph | CH₂CH₂ |
| 194 | CN | 1 | OCF₃ | H | H | H | Ph | CH₂CH₂ |
| 195 | CN | 2 | OCF₃ | H | H | H | Ph | CH₂CH₂ |
| 196 | CN | 0 | CF₃ | H | H | H | H | O |
| 197 | CN | 1 | CF₃ | H | H | H | H | O |
| 198 | CN | 2 | CF₃ | H | H | H | H | O |
| 199 | CN | 0 | CF₃ | Me | H | H | H | O |
| 200 | CN | 1 | CF₃ | Me | H | H | H | O |
| 201 | CN | 2 | CF₃ | Me | H | H | H | O |
| 202 | CN | 0 | CF₃ | H | Me | H | H | O |
| 203 | CN | 1 | CF₃ | H | Me | H | H | O |
| 204 | CN | 2 | CF₃ | H | Me | H | H | O |
| 205 | CN | 0 | CF₃ | H | H | Me | H | O |
| 206 | CN | 1 | CF₃ | H | H | Me | H | O |
| 207 | CN | 2 | CF₃ | H | H | Me | H | O |
| 208 | CN | 0 | CF₃ | H | H | H | Me | O |
| 209 | CN | 1 | CF₃ | H | H | H | Me | O |
| 210 | CN | 2 | CF₃ | H | H | H | Me | O |
| 211 | CN | 0 | CF₃ | Ph | H | H | H | O |
| 212 | CN | 1 | CF₃ | Ph | H | H | H | O |
| 213 | CN | 2 | CF₃ | Ph | H | H | H | O |
| 214 | CN | 0 | CF₃ | H | Ph | H | H | O |
| 215 | CN | 1 | CF₃ | H | Ph | H | H | O |
| 216 | CN | 2 | CF₃ | H | Ph | H | H | O |
| 217 | CN | 0 | CF₃ | H | H | Ph | H | O |
| 218 | CN | 1 | CF₃ | H | H | Ph | H | O |
| 219 | CN | 2 | CF₃ | H | H | Ph | H | O |
| 220 | CN | 0 | CF₃ | H | H | H | Ph | O |
| 221 | CN | 1 | CF₃ | H | H | H | Ph | O |
| 222 | CN | 2 | CF₃ | H | H | H | Ph | O |
| 223 | CN | 0 | OCF₃ | H | H | H | H | O |
| 224 | CN | 1 | OCF₃ | H | H | H | H | O |
| 225 | CN | 2 | OCF₃ | H | H | H | H | O |
| 226 | CN | 0 | OCF₃ | Me | H | H | H | O |
| 227 | CN | 1 | OCF₃ | Me | H | H | H | O |
| 228 | CN | 2 | OCF₃ | Me | H | H | H | O |
| 229 | CN | 0 | OCF₃ | H | Me | H | H | O |
| 230 | CN | 1 | OCF₃ | H | Me | H | H | O |
| 231 | CN | 2 | OCF₃ | H | Me | H | H | O |
| 232 | CN | 0 | OCF₃ | H | H | Me | H | O |
| 233 | CN | 1 | OCF₃ | H | H | Me | H | O |
| 234 | CN | 2 | OCF₃ | H | H | Me | H | O |
| 235 | CN | 0 | OCF₃ | H | H | H | Me | O |
| 236 | CN | 1 | OCF₃ | H | H | H | Me | O |
| 237 | CN | 2 | OCF₃ | H | H | H | Me | O |
| 238 | CN | 0 | OCF₃ | Ph | H | H | H | O |
| 239 | CN | 1 | OCF₃ | Ph | H | H | H | O |
| 240 | CN | 2 | OCF₃ | Ph | H | H | H | O |
| 241 | CN | 0 | OCF₃ | H | Ph | H | H | O |
| 242 | CN | 1 | OCF₃ | H | Ph | H | H | O |
| 243 | CN | 2 | OCF₃ | H | Ph | H | H | O |
| 244 | CN | 0 | OCF₃ | H | H | Ph | H | O |
| 245 | CN | 1 | OCF₃ | H | H | Ph | H | O |
| 246 | CN | 2 | OCF₃ | H | H | Ph | H | O |
| 247 | CN | 0 | OCF₃ | H | H | H | Ph | O |
| 248 | CN | 1 | OCF₃ | H | H | H | Ph | O |
| 249 | CN | 2 | OCF₃ | H | H | H | Ph | O |

The compounds of general formula (I) can be prepared by the application or adaptation of known methods (i.e. methods heretofore used or described in the chemical literature.

According to a feature of the invention compounds of formula (I) wherein R¹, R², R³, R⁴, R⁵, W, A, D and G are as defined above and n is zero may be prepared by the cycloaddition reaction of a compound of formula (II):

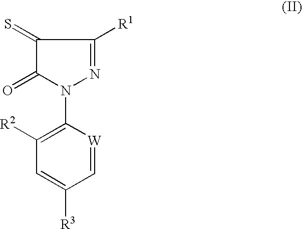

wherein R¹, R², R³ and W are defined above, with a diene compound of formula (III):

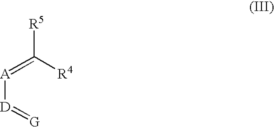

wherein R⁴, R⁵, A, D and G are defined above. The reaction is generally performed in a solvent such as dichloromethane, ethyl acetate, toluene, anisole or chlorobenzene, at a temperature of from 0° to 200° C. (preferably 0° to 60° C.), optionally in the presence of a catalyst, preferably a Lewis acid such as tin (IV) chloride, zinc (II) chloride, aluminium (III) chloride or boron trifluoride, and optionally under pressure. As is well known in Diels Alder reactions (see for example F. Fringuella and A. Taticchi in “Dienes in the Diels Alder Reaction”, Wiley 1990), regioisomers and stereoisomers may in general be obtained, however in many instances one isomer of formula (I) is found to predominate. Intermediates of formula (II) wherein R¹, R², R³ and W are defined above, may be prepared by the thermal decomposition of sulfenamides of formula (IV):

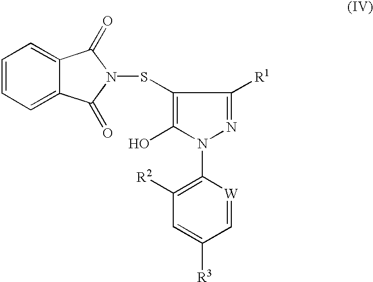

by heating at a temperature of from 0-100° C. (preferably 0-50° C.), preferably in the presence of a base such as pyridine.

Intermediates of formula (IV) wherein R¹, R², R³ and W are defined above may be prepared by the sulfenylation of a compound of formula (V):

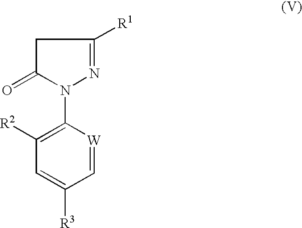

wherein R¹, R², R³ and W are defined above, with N-chlorosulfenylphthalimide of formula (VI):

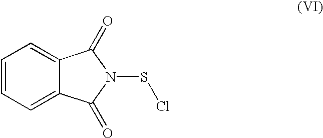

The reaction is generally performed in the presence of a base such as triethylamine, in a solvent such as dichloromethane at a temperature of from −70° C. to +50° C. The sulfenamide intermediates of formula (IV) are generally rather unstable and are not usually isolated and are generally converted directly into the compound of formula (II).

According to a further feature of the invention compounds of formula (I) wherein R¹, R², R³, R⁴, R⁵, W, A, D and G are as defined above, and n is zero may also be prepared directly from a compound of formula (V) by reaction with a compound of formula (VI) as described above, followed by addition of a compound of formula (III) to the resulting reaction mixture, followed by the thermal decomposition of the resulting compound of formula (IV) as described above, to give a compound of formula (II), which reacts in situ with the compound of formula (III), to give the compound of formula (I).

According to a further feature of the invention compounds of formula (I) wherein R¹, R², R³, R⁴, R⁵, W, A, D and G are as defined above, and n is 1 or 2 may be prepared by oxidising a corresponding compound in which n is 0 or 1. The oxidation is generally performed using a peracid such as 3-chloroperbenzoic acid in a solvent such as dichloromethane or ethanol, at a temperature of from 0° C. to the reflux temperature of the solvent.

Collections of compounds of the formula (I) which can be synthesized by the above mentioned process may also be prepared in a parallel manner, and this may be effected manually or in a semiautomated or fully automated manner. In this case, it is possible, for example, to automate the procedure of the reaction, work-up or purification of the products or of the intermediates. In total, this is to be understood as meaning a procedure as is described, for example, by S. H. DeWitt in “Annual Reports in Combinatorial Chemistry and Molecular Diversity: Automated Synthesis”, Volume 1, Verlag Escom 1997, pages 69 to 77.

A series of commercially available apparatuses as are offered by, for example, Stem Corporation, Woodrolfe Road, Tollesbury, Essex, CM98SE, England or H+P Labortechnik GmbH, Bruckmannring 28, 85764 Oberschleiβheim, Germany or Radleys, Shirehill, Saffron Walden, Essex, England, may be used for the parallel procedure of the reaction and work-up. For the parallel purification of compounds of the formula (I), or of intermediates obtained during the preparation, use may be made, inter alia, of chromatography apparatuses, for example those by ISCO, Inc., 4700 Superior Street, Lincoln, Nebr. 68504, USA.

The apparatuses mentioned lead to a modular procedure in which the individual process steps are automated, but manual operations must be performed between the process steps. This can be prevented by employing semi-integrated or fully integrated automation systems where the automation modules in question are operated by, for example, robots. Such automation systems can be obtained, for example, from Zymark Corporation, Zymark Center, Hopkinton, Mass. 01748, USA.

In addition to what has been described here, compounds of the formula (I) may be prepared in part or fully by solid-phase-supported methods. For this purpose, individual intermediate steps or all intermediate steps of the synthesis or of a synthesis adapted to suit the procedure in question are bound to a synthetic resin. Solid-phase-supported synthesis methods are described extensively in the specialist literature, for example Barry A. Bunin in “The Combinatorial Index”, Academic Press, 1998.

The use of solid-phase-supported synthesis methods permits a series of protocols which are known from the literature and which, in turn, can be performed manually or in an automated manner. For example, the “tea-bag method” (Houghten, U.S. Pat. No. 4,631,211; Houghten et al., Proc. Natl. Acad. Sci, 1985, 82, 5131-5135), in which products by IRORI, 11149 North Torrey Pines Road, La Jolla, Calif. 92037, USA, are employed, may be semiautomated. The automation of solid-phase-supported parallel syntheses is performed successfully, for example, by apparatuses by Argonaut Technologies, Inc., 887 Industrial Road, San Carlos, Calif. 94070, USA or MultiSynTech GmbH, Wullener Feld 4, 58454 Witten, Germany.

The preparation of the processes described herein yields compounds of the formula (I) in the form of substance collections which are termed libraries. The present invention also relates to libraries which comprise at least two compounds of the formula (I).

Compounds of formula (II) and (IV) are novel and as such form a further feature of the invention, with the following provisos:

3-methyl-1-phenylpyrazolin-5-one-4-thione;

3-amino-1-phenylpyrazolin-5-one-4-thione;

3-methyl-1-phenyl-4-(N-phthalimidosulfenyl)pyrazolin-5-one; and

3-amino-1-phenyl-4-(N-phthalimidosulfenyl)pyrazolin-5-one.

Compounds of formula (III), (V) and (VI) are known or may be prepared by known methods.

The invention is illustrated by the following non-limiting examples.

### EXAMPLE 1

A mixture of 3-methyl-1-phenylpyrazolin-5-one (5.91 mmol) and triethylamine (5.91 mmol) was added dropwise during 0.5 hour to a stirred solution of N-chlorosulfenylphthalimide (6.5 mmol) in dichloromethane at −70° C. The mixture was warmed to 0-2° C. over 40 minutes and 2,3-dimethylbuta-1,3-diene (11.81 mmol) added, then warmed to 20° C. and pyridine (17.73 mmol) added. After 24 hours the phthalimide was filtered off, the solution evaporated and extracted (n-hexane) and crystallised to give (3-methyl-1-phenylpyrazolin-5-one)-4-spiro-2′-(4′,5′-dimethyl-2′H-3′,6′-dihydrothiane) (compound 1), mp 83-85° C.

By proceeding in a similar manner the following compounds of formula (I) were also prepared:

(3-amino-1-phenylpyrazolin-5-one)-4-spiro-2′-(4′,5′-dimethyl-2′H-3′,6′-dihydrothiane) (compound 2), mp 128-131° C.;

[1-(2,6-dichloro-4-trifluoromethylphenyl)-3-methylpyrazolin-5-one]-4-spiro-2′-(5′-phenyl-2′H-3′,6′-dihydrothiane) (compound 3), mp 149-152° C. (from 2-phenylbuta-1,3-diene);[1-(2,6-dichloro-4-trifluoromethylphenyl)-3-methylpyrazolin-5-one]-4-spiro-2′-(3′-trimethylsilyloxy-2′H-3′,6′-dihydrothiane) (compound 4), as a 57:43 mixture of diastereoisomers, mp 54-58° C. (from 1-trimethylsilyloxybuta-1,3-diene);[1-(2,6-dichloro-4-trifluoromethylphenyl)-3-methylpyrazolin-5-one]-4-spiro-2′-(4′,5′-dimethyl-2′H-3′,6′-dihydrothiane) (compound 5), mp 99° C. (from 2,3-dimethylbuta-1,3-diene);

[3-amino-1-(2,6-dichloro-4-trifluoromethylphenyl)pyrazolin-5-one]-4-spiro-2′-(4′,5′-dimethyl-2′H-3′,6′-dihydrothiane) (compound 6), mp 133-135° C. (from 2,3-dimethylbuta-1,3-diene);

[3-amino-1-(2,6-dichloro-4-trifluoromethylphenyl)pyrazolin-5-one]-4-spiro-3′-(2′-thiabicyclo[2.2.1]hept-5′-ene) (compound 7), mp 151-153° C. (from cyclopenta-1,3-diene);

[1-(2,6-dichloro-4-trifluoromethylphenyl)-3-methylpyrazolin-5-one]-4-spiro-3′-(2′-thiabicyclo[2.2.1]hept-5′-ene) (compound 8), mp 157-160° C. (from cyclopenta-1,3-diene);

[1-(2,6-dichloro-4-trifluoromethylphenyl)-3-cyanopyrazolin-5-one]-4-spiro-2′-(4′,5′-dimethyl-2′H-3′,6′-dihydrothiane) (compound 9), mp 128-131° C. (from 2,3-dimethylbuta-1,3-diene); and

(3-methyl-1-phenylpyrazolin-5-one)-4-spiro-3′-(2′-thiabicyclo[2.2.1]hept-5′-ene) (compound 10), NMR (DMSO-d6) (for major diastereomer) 1.63 (s,3H), 1.13 and 2.99 (2H), 2.81 (s,1H), 3.62 (s,1H), 5.29 (dd,1H), 6.00 (dd,1H), 6.96 (1H), 7.23 (2H), 8.38 (d,2H). (from cyclopenta-1,3-diene);

[1-(2,6-dichloro-4-trifluoromethylphenyl)-3-cyanopyrazolin-5-one]-4-spiro-2′-(5′-phenyl-2′H-3′,6′-dihydrothiane) (compound 17), mp 156-158° C.; [1-(2,6-dichloro-4-trifluoromethylphenyl)-3-methylpyrazolin-5-one]-4-spiro-2′-(6′-phenyl-2′H-3′,6′-dihydrothiane) and [1-(2,6-dichloro-4-trifluoromethylphenyl)-3-methylpyrazolin-5-one]-4-spiro-2′-(3′-phenyl-2′H-3′,6′-dihydrothiane) (compound 20), mp 51-53° C.; and

[1-(2,6-dichloro-4-trifluoromethylphenyl)-3-methylpyrazolin-5-one]-4-spiro-2′-(6′-methyl-2′H-3′,6′-dihydrothiane) and [1-(2,6-dichloro-4-trifluoromethylphenyl)-3-methylpyrazolin-5-one]-4-spiro-2′-(3′-methyl-2′H-3′,6′-dihydrothiane) (compound 21).

### EXAMPLE 2

A solution of 3-chloroperbenzoic acid (1.75 mmol) in chloroform was added to a stirred solution of (3-methyl-1-phenylpyrazolin-5-one)-4-spiro-2′-(4′,5′-dimethyl-2′H-3′,6′-dihydrothiane) (1.75 mmol) in chloroform. After 24 hours the solvent was evaporated and the residue crystallised from ethanol to give (3-methyl-1-phenylpyrazolin-5-one)-4-spiro-2′-(4′,5′-dimethyl-1′-oxo-2′H-3′,6′-dihydrothiane) (compound 11), mp 112-115° C.

By proceeding in a similar manner the following compounds of formula (I) were also prepared:

[1-(2,6-dichloro-4-trifluoromethylphenyl)-3-methylpyrazolin-5-one]-4-spiro-2′-(5′-phenyl-1′-oxo-2′H-3′,6′-dihydrothiane) (compound 12), mp 145-148° C.;

[1-(2,6-dichloro-4-trifluoromethylphenyl)-3-methylpyrazolin-5-one]4-spiro-2′-(4′,5′-dimethyl-1′-oxo-2′H-3′,6′-dihydrothiane) (compound 13), mp 137-140° C.; and

[1-(2,6-dichloro-4-trifluoromethylphenyl)-3-cyanopyrazolin-5-one]-4-spiro-2′-(4′,5′-dimethyl-1′-oxo-2′H-3′,6′-dihydrothiane) (compound 19), mp 105-115° C.

### EXAMPLE 3

3-Chloroperbenzoic acid (3.5 mmol) in chloroform was added to a stirred solution of (3-methyl-1-phenylpyrazolin-5-one)-4-spiro-2′-(4′,5′-dimethyl-2′H-3′,6′-dihydrothiane) (1.75 mmol) in ethanol. After 5 hours the solid was filtered off and crystallised from ethanol to give (3-methyl-1-phenylpyrazolin-5-one)-4-spiro-2′-(4′,5′-dimethyl-1,1′-dioxo-2′H-3′,6′-dihydrothiane) (compound 14), NMR (DMSO-d6) 1.71 (s,3H), 1.75 (s,3H), 2.31 (s,3H), 2.92 and 3.14 (2H), 3.86 and 4.21 (2H), 7.26 (1H), 7.46 (2H), 7.79 (2H).

By proceeding in a similar manner the following compounds of formula (I) were also prepared:

[1-(2,6-dichloro-4-trifluoromethylphenyl)-3-methylpyrazolin-5-one]-4-spiro-2′-(5′-phenyl-1′,1′-dioxo-2′H-3′,6′-dihydrothiane) (compound 15), mp 202-205° C.;

[1-(2,6-dichloro-4-trifluoromethylphenyl)-3-methylpyrazolin-5-one]-4-spiro-2′-(4′,5′-dimethyl-1′,1′-dioxo-2′H-3′,6′-dihydrothiane) (compound 16), mp 163-165° C.; and

[1-(2,6-dichloro-4-trifluoromethylphenyl)-3-cyanopyrazolin-5-one]-4-spiro-2′-(4′,5′-dimethyl-1′,1′-dioxo-2′H-3′,6′-dihydrothiane) (compound 18), mp 55° C.

The term “compound of the invention” as used hereinafter embraces a 4-spirocyclic pyrazole of formula (I) as defined above and a pesticidally acceptable salt thereof.

One aspect of the present invention as defined above is a method for the control of pests at a locus. The locus includes, for example, the pest itself, the place (plant, field, forest, orchard, waterway, soil, plant product, or the like) where the pest resides or feeds, or a place susceptible to future infestation by the pest. The compound of the invention may therefore be applied directly to the pest, to the place where the pest resides or feeds, or to the place susceptible to future infestation by the pest.

As is evident from the foregoing pesticidal uses, the present invention provides pesticidally active compounds and methods of use of said compounds for the control of a number of pest species which includes: arthropods, especially insects or mites, or plant nematodes. The compound of the invention may thus be advantageously employed in practical uses, for example, in agricultural or horticultural crops, in forestry, in veterinary medicine or livestock husbandry, or in public health.

The compounds of the invention may be used for example in the following applications and on the following pests:

For the control of soil insects, such as corn rootworm, termites (especially for protection of structures), root maggots, wireworms, root weevils, stalkborers, cutworms, root aphids, or grubs. They may also be used to provide activity against plant pathogenic nematodes, such as root-knot, cyst, dagger, lesion, or stem or bulb nematodes, or against mites. For the control of soil pests, for example corn rootworm, the compounds are advantageously applied to or incorporated at an effective rate into the soil in which crops are planted or to be planted or to the seeds or growing plant roots.

In the area of public health, the compounds are especially useful in the control of many insects, especially filth flies or other Dipteran pests, such as houseflies, stableflies, soldierflies, hornflies, deerflies, horseflies, midges, punkies, blackflies, or mosquitoes.

In the protection of stored products, for example cereals, including grain or flour, groundnuts, animal feedstuffs, timber or household goods, e.g. carpets and textiles, compounds of the invention are useful against attack by arthropods, more especially beetles, including weevils, moths or mites, for example Ephestia spp. (flour moths), Anthrenus spp. (carpet beetles), Tribolium spp. (flour beetles), Sitophilus spp. (grain weevils) or Acarus spp. (mites).

In the control of cockroaches, ants or termites or similar arthropod pests in infested domestic or industrial premises or in the control of mosquito larvae in waterways, wells, reservoirs or other running or standing water.

For the treatment of foundations, structures or soil in the prevention of the attack on building by termites, for example, Reticulitermes spp., Heterotermes spp., Coptotermes spp.

In agriculture against adults, larvae and eggs of Lepidoptera (butterflies and moths), e.g. Heliothis spp. such as Heliothis virescens (tobacco budworm), Heliothis armigera and Heliothis zea. Against adults and larvae of Coleoptera (beetles) e.g. Anthonomus spp. e.g. grandis (cotton boll weevil), Leptinotarsa decemlineata (Colorado potato beetle), Diabrotica spp. (corn rootworms). Against Heteroptera (Hemiptera and Homoptera) e.g. Psylla spp., Bemisia spp., Trialeurodes spp., Aphis spp., Myzus spp., Megoura viciae, Phylloxera spp., Nephotettix spp. (rice leaf hoppers), Nilaparvata spp.

Against Diptera e.g. Musca spp. Against Thysanoptera such as Thrips tabaci. Against Orthoptera such as Locusta and Schistocerca spp., (locusts and crickets) e.g. Gryllus spp., and Acheta spp. for example, Blatta orientalis, Periplaneta americana, Blatella germanica, Locusta migratoria migratorioides, and Schistocerca gregaria. Against Collembola e.g. Periplaneta spp. and Blatella spp. (roaches).

Against arthropods of agricultural significance such as Acari (mites) e.g. Tetranychus spp., and Panonychus spp.

Against nematodes which attack plants or trees of importance to agriculture, forestry or horticulture either directly or by spreading bacterial, viral, mycoplasma or fungal diseases of the plants. For example root-knot nematodes such as Meloidogyne spp. (e.g. M. incognita).

In the field of veterinary medicine or livestock husbandry or in the maintenance of public health against arthropods which are parasitic internally or externally upon vertebrates, particularly warm-blooded vertebrates, for example domestic animals, e.g. cattle, sheep, goats, equines, swine, poultry, dogs or cats, for example Acarina, including ticks (e.g. Ixodes spp., Boophilus spp. e.g. Boophilus microplus, Rhipicephalus spp. e.g. Rhipicephalus appendiculatus Ornithodorus spp. (e.g. Ornithodorus moubata) and mites (e.g. Damalinia spp.); fleas; Diptera (e.g. Aedes spp., Anopheles spp., Musca spp., Hypoderma spp.); Hemiptera.; Dictyoptera (e.g. Periplaneta spp., Blatella spp.); Hymenoptera; for example against infections of the gastrointestinal tract caused by parasitic nematode worms, for example members of the family Trichostrongylidae.

In practical use for the control of arthropods, especially insects or mites, or nematode pests of plants, a method, for example, comprises applying to the plants or to the medium in which they grow an effective amount of a compound of the invention. For such a method, the active compound is generally applied to the locus in which the arthropod or nematode infestation is to be controlled at an effective rate in the range of about 2 g to about 1 kg of the active compound per hectare of locus treated. Under ideal conditions, depending on the pest to be controlled, a lower rate may offer adequate protection. On the other hand, adverse weather conditions, resistance of the pest or other factors may require that the active ingredient be used at higher rates. The optimum rate depends usually upon a number of factors, for example, the type of pest being controlled, the type or the growth stage of the infested plant, the row spacing or also the method of application. Preferably an effective rate range of the active compound is from about 10 g/ha to about 400 g/ha, more preferably from about 50 g/ha to about 200 g/ha.

When a pest is soil-borne, the active compound generally in a formulated composition, is distributed evenly over the area to be treated (ie, for example broadcast or band treatment) in any convenient manner and is applied at rates from about 10 g/ha to about 400 g ai/ha, preferably from about 50 g/ha to about 200 g ai/ha. When applied as a root dip to seedlings or drip irrigation to plants the liquid solution or suspension contains from about 0.075 to about 1000 mg ai/l, preferably from about 25 to about 200 mg ai/l. Application may be made, if desired, to the field or crop-growing area generally or in close proximity to the seed or plant to be protected from attack. The active component can be washed into the soil by spraying with water over the area or can be left to the natural action of rainfall. During or after application, the formulated compound can, if desired, be distributed mechanically in the soil, for example by ploughing, disking, or use of drag chains. Application can be prior to planting, at planting, after planting but before sprouting has taken place, or after sprouting.

The compound of the invention and methods of control of pests therewith are of particular value in the protection of field, forage, plantation, glasshouse, orchard or vineyard crops, of ornamentals, or of plantation or forest trees, for example: cereals (such as wheat or rice), cotton, vegetables (such as peppers), field crops (such as sugar beets, soybeans or oil seed rape), grassland or forage crops (such as maize or sorghum), orchards or groves (such as of stone or pit fruit or citrus), ornamental plants, flowers or vegetables or shrubs under glass or in gardens or parks, or forest trees (both deciduous and evergreen) in forests, plantations or nurseries. They are also valuable in the protection of timber (standing, felled, converted, stored or structural) from attack, for example, by sawflies or beetles or termites.

They have applications in the protection of stored products such as grains, fruits, nuts, spices or tobacco, whether whole, milled or compounded into products, from moth, beetle, mite or grain weevil attack. Also protected are stored animal products such as skins, hair, wool or feathers in natural or converted form (e.g. as carpets or textiles) from moth or beetle attack as well as stored meat, fish or grains from beetle, mite or fly attack.

Additionally, the compound of the invention and methods of use thereof are of particular value in the control of arthropods or helminths which are injurious to, or spread or act as vectors of diseases domestic animals, for example those hereinbefore mentioned, and more especially in the control of ticks, mites, lice, fleas, midges, or biting, nuisance or myiasis flies. The compounds of the invention are particularly useful in controlling arthropods or helminths which are present inside domestic host animals or which feed in or on the skin or suck the blood of the animal, for which purpose they may be administered orally, parenterally, percutaneously or topically.

The compositions hereinafter described for application to growing crops or crop growing loci or as a seed dressing may, in general, alternatively be employed in the protection of stored products, household goods, property or areas of the general environment. Suitable means of applying the compounds of the invention include:

to growing crops as foliar sprays (for example as an in-furrow spray), dusts, granules, fogs or foams or also as suspensions of finely divided or encapsulated compositions as soil or root treatments by liquid drenches, dusts, granules, smokes or foams; to seeds of crops via application as seed dressings by liquid slurries or dusts;

to animals infested by or exposed to infestation by arthropods or helminths, by parenteral, oral or topical application of compositions in which the active ingredient exhibits an immediate and/or prolonged action over a period of time against the arthropods or helminths, for example by incorporation in feed or suitable orally-ingestible pharmaceutical formulations, edible baits, salt licks, dietary supplements, pour-on formulations, sprays, baths, dips, showers, jets, dusts, greases, shampoos, creams, wax smears or livestock self-treatment systems;

to the environment in general or to specific locations where pests may lurk, including stored products, timber, household goods, or domestic or industrial premises, as sprays, fogs, dusts, smokes, wax-smears, lacquers, granules or baits, or in tricklefeeds to waterways, wells, reservoirs or other running or standing water.

The compounds of the formula (I) can also be employed for controlling harmful organisms in crops of known genetically engineered plants or genetically engineered plants yet to be developed. As a rule, the transgenic plants are distinguished by especially advantageous properties, for example by resistances to particular crop protection agents, resistances to plant diseases or pathogens of plant diseases, such as particular insects or microorganisms such as fungi, bacteria or viruses. Other particular properties concern, for example, the harvested material with regard to quantity, quality, storage properties, composition and specific constituents. Thus, transgenic plants are known where the starch content is increased, or the starch quality is altered, or where the harvested material has a different fatty acid composition.

The use in economically important transgenic crops of useful plants and ornamentals is preferred, for example of cereals such as wheat, barley, rye, oats, millet, rice, cassaya and maize or else crops of sugar beet, cotton, soya, oilseed rape, potatoes, tomatoes, peas and other types of vegetables.

When used in transgenic crops, in particular those which have resistances to insects, effects are frequently observed, in addition to the effects against harmful organisms to be observed in other crops, which are specific for application in the transgenic crop in question, for example an altered or specifically widened spectrum of pests which can be controlled, or altered application rates which may be employed for application.

The invention therefore also relates to the use of compounds of the formula (I) for controlling harmful organisms in transgenic crop plants.

According to a further feature of the present invention there is provided a pesticidal composition comprising one or more compounds of the invention as defined above, in association with, and preferably homogeneously dispersed in one or more compatible agriculturally acceptable diluents or carriers and/or surface active agents [i.e. diluents or carriers and/or surface active agents of the type generally accepted in the art as being suitable for use in herbicidal compositions and which are compatible with compounds of the invention].

In practice, the compounds of the invention most frequently form parts of compositions. These compositions can be employed to control arthropods, especially insects, or plant nematodes or mites. The compositions may be of any type known in the art suitable for application to the desired pest in any premises or indoor or outdoor area. These compositions contain at least one compound of the invention as the active ingredient in combination or association with one or more other compatible components which are for example, solid or liquid carriers or diluents, adjuvants, surface-active-agents, or the like appropriate for the intended use and which are agronomically or medicinally acceptable. These compositions, which may be prepared by any manner known in the art, likewise form a part of this invention.

These compositions may also contain other kinds of ingredients such as protective colloids, adhesives, thickeners, thixotropic agents, penetrating agents, spray oils (especially for acaridical use), stabilizers, preservative agents (especially mold preservatives), sequestering agents, or the like, as well as other known active ingredients with pesticidal properties (particularly insecticidal, miticidal, nematicidal, or fungicidal) or with properties regulating the growth of plants. More generally, the compounds employed in the invention may be combined with all the solid or liquid additives corresponding to the usual techniques of formulation.

Examples of other pesticidally-active compounds which may be included in, or used in conjunction with the compositions of the present invention are: acephate, chlorpyrifos, demeton-S-methyl, disulfoton, ethoprofos, fenitrothion, fenamiphos, fonofos, isazophos, isofenphos, malathion, monocrotophos, parathion, phorate, phosalone, pirimiphos-methyl, terbufos, triazophos, cyfluthrin, cypermethrin, deltamethrin, fenpropathrin, fenvalerate, permethrin, tefluthrin, aldicarb, carbosulfan, methomyl, oxamyl, pirimicarb, bendiocarb, teflubenzuron, dicofol, endosulfan, lindane, benzoximate, cartap, cyhexatin, tetradifon, avermectins, ivermectins, milbemycins, thiophanate, trichlorfon, dichlorvos, diaveridine or dimetriadazole.

Compositions, suitable for applications in agriculture, horticulture, or the like include formulations suitable for use as, for example, sprays, dusts, granules, fogs, foams, emulsions, or the like.

The effective use doses of the compounds employed in the invention can vary within wide limits, particularly depending on the nature of the pest to be eliminated or degree of infestation, for example, of crops with these pests. In general, the compositions according to the invention usually contain about 0.05 to about 95% (by weight) of one or more active ingredients according to the invention, about 1 to about 95% of one or more solid or liquid carriers and, optionally, about 0.1 to about 50% of one or more other compatible components, such as surface-active agents or the like.

In the present account, the term “carrier” denotes an organic or inorganic ingredient, natural or synthetic, with which the active ingredient is combined to facilitate its application, for example, to the plant, to seeds or to the soil. This carrier is therefore generally inert and it must be acceptable (for example, agronomically acceptable, particularly to the treated plant).

The carrier may be a solid, for example, clays, natural or synthetic silicates, silica, resins, waxes, solid fertilizers (for example ammonium salts), ground natural minerals, such as kaolins, clays, talc, chalk, quartz, attapulgite, montmorillonite, bentonite or diatomaceous earth, or ground synthetic minerals, such as silica, alumina, or silicates especially aluminium or magnesium silicates. As solid carriers for granules the following are suitable: crushed or fractionated natural rocks such as calcite, marble, pumice, sepiolite and dolomite; synthetic granules of inorganic or organic meals; granules of organic material such as sawdust, coconut shells, corn cobs, corn husks or tobacco stalks; kieselguhr, tricalcium phosphate, powdered cork, or absorbent carbon black; water soluble polymers, resins, waxes; or solid fertilizers. Such solid compositions may, if desired, contain one or more compatible wetting, dispersing, emulsifying or colouring agents which, when solid, may also serve as a diluent.

The carrier may also be liquid, for example: water; alcohols, particularly butanol or glycol, as well as their ethers or esters, particularly methylglycol acetate; ketones, particularly acetone, cyclohexanone, methylethyl ketone, methylisobutylketone, or isophorone; petroleum fractions such as paraffinic or aromatic hydrocarbons, particularly xylenes or alkyl naphthalenes; mineral or vegetable oils; aliphatic chlorinated hydrocarbons, particularly trichloroethane or methylene chloride; aromatic chlorinated hydrocarbons, particularly chlorobenzenes; water-soluble or strongly polar solvents such as dimethylformamide, dimethyl sulphoxide, or N-methylpyrrolidone; liquefied gases; or the like or a mixture thereof.

The surface-active agent may be an emulsifying agent, dispersing agent or wetting agent of the ionic or non-ionic type or a mixture of such surface-active agents. Amongst these are e.g., salts of polyacrylic acids, salts of lignosulphonic acids, salts of phenolsulphonic or naphthalenesulphonic acids, polycondensates of ethylene oxide with fatty alcohols or fatty acids or fatty esters or fatty amines, substituted phenols (particularly alkylphenols or arylphenols), salts of sulphosuccinic acid esters, taurine derivatives (particularly alkyltaurates), phosphoric esters of alcohols or of polycondensates of ethylene oxide with phenols, esters of fatty acids with polyols, or sulphate, sulphonate or phosphate functional derivatives of the above compounds. The presence of at least one surface-active agent is generally essential when the active ingredient and/or the inert carrier are only slightly water soluble or are not water soluble and the carrier agent of the composition for application is water.

Compositions of the invention may further contain other additives such as adhesives or colorants. Adhesives such as carboxymethylcellulose or natural or synthetic polymers in the form of powders, granules or lattices, such as arabic gum, polyvinyl alcohol or polyvinyl acetate, natural phospholipids, such as cephalins or lecithins, or synthetic phospholipids can be used in the formulations. It is possible to use colorants such as inorganic pigments, for example: iron oxides, titanium oxides or Prussian Blue; organic dyestuffs, such as alizarin dyestuffs, azo dyestuffs or metal phthalocyanine dyestuffs; or trace nutrients such as salts of iron, manganese, boron, copper, cobalt, molybdenum or zinc.

For their agricultural application, the compounds of the invention are therefore generally in the form of compositions, which are in various solid or liquid forms.

Solid forms of compositions which can be used are dusting powders (with a content of the compound of the invention, ranging up to 80%), wettable powders or granules (including water dispersible granules), particularly those obtained by extrusion, compacting, impregnation of a granular carrier, or granulation starting from a powder (the content of the compound of the invention, in these wettable powders or granules being between about 0.5 and about 80%). Solid homogenous or heterogenous compositions containing one or more compounds of the invention, for example granules, pellets, briquettes or capsules, may be used to treat standing or running water over a period of time. A similar effect may be achieved using trickle or intermittent feeds of water dispersible concentrates as described herein.

Liquid compositions, for example, include aqueous or non-aqueous solutions or suspensions (such as emulsifiable concentrates, emulsions, flowables, dispersions, or solutions) or aerosols. Liquid compositions also include, in particular, emulsifiable concentrates, dispersions, emulsions, flowables, aerosols, wettable powders (or powder for spraying), dry flowables or pastes as forms of compositions which are liquid or intended to form liquid compositions when applied, for example as aqueous sprays (including low and ultra-low volume) or as fogs or aerosols.

Liquid compositions, for example, in the form of emulsifiable or soluble concentrates most frequently comprise about 5 to about 80% by weight of the active ingredient, while the emulsions or solutions which are ready for application contain, in their case, about 0.01 to about 20% of the active ingredient. Besides the solvent, the emulsifiable or soluble concentrates may contain, when required, about 2 to about 50% of suitable additives, such as stabilizers, surface-active agents, penetrating agents, corrosion inhibitors, colorants or adhesives. Emulsions of any required concentration, which are particularly suitable for application, for example, to plants, may be obtained from these concentrates by dilution with water. These compositions are included within the scope of the compositions which may be employed in the present invention. The emulsions may be in the form of water-in-oil or oil-in-water type and they may have a thick consistency.

The liquid compositions of this invention may, in addition to normal agricultural use applications be used for example to treat substrates or sites infested or liable to infestation by arthropods (or other pests controlled by compounds of this invention) including premises, outdoor or indoor storage or processing areas, containers or equipment or standing or running water.

All these aqueous dispersions or emulsions or spraying mixtures can be applied, for example, to crops by any suitable means, chiefly by spraying, at rates which are generally of the order of about 100 to about 1,200 liters of spraying mixture per hectare, but may be higher or lower (eg. low or ultra-low volume) depending upon the need or application technique. The compound or compositions according to the invention are conveniently applied to vegetation and in particular to roots or leaves having pests to be eliminated. Another method of application of the compounds or compositions according to the invention is by chemigation, that is to say, the addition of a formulation containing the active ingredient to irrigation water. This irrigation may be sprinkler irrigation for foliar pesticides or it can be ground irrigation or underground irrigation for soil or for systemic pesticides.

The concentrated suspensions, which can be applied by spraying, are prepared so as to produce a stable fluid product which does not settle (fine grinding) and usually contain from about 10 to about 75% by weight of active ingredient, from about 0.5 to about 30% of surface-active agents, from about 0.1 to about 10% of thixotropic agents, from about 0 to about 30% of suitable additives, such as anti-foaming agents, corrosion inhibitors, stabilizers, penetrating agents, adhesives and, as the carrier, water or an organic liquid in which the active ingredient is poorly soluble or insoluble Some organic solids or inorganic salts may be dissolved in the carrier to help prevent settling or as antifreezes for water.

The wettable powers (or powder for spraying) are usually prepared so that they contain from about 10 to about 80% by weight of active ingredient, from about 20 to about 90% of a solid carrier, from about 0 to about 5% of a wetting agent, from about 3 to about 10% of a dispersing agent and, when necessary, from about 0 to about 80% of one or more stabilizers and/or other additives, such as penetrating agents, adhesives, anti-caking agents, colorants, or the like. To obtain these wettable powders, the active ingredient is thoroughly mixed in a suitable blender with additional substances which may be impregnated on the porous filler and is ground using a mill or other suitable grinder. This produces wettable powders, the wettability and the suspendability of which are advantageous. They may be suspended in water to give any desired concentration and this suspension can be employed very advantageously in particular for application to plant foliage.

The “water dispersible granules (WG)” (granules which are readily dispersible in water) have compositions which are substantially close to that of the wettable powders. They may be prepared by granulation of formulations described for the wettable powders, either by a wet route (contacting finely divided active ingredient with the inert filler and a little water, e.g. 1 to 20% by weight, or with an aqueous solution of a dispersing agent or binder, followed by drying and screening), or by a dry route (compacting followed by grinding and screening).

The rates and concentrations of the formulated compositions may vary according to the method of application or the nature of the compositions or use thereof. Generally speaking, the compositions for application to control arthropod or plant nematode pests usually contain from about 0.00001% to about 95%, more particularly from about 0.0005% to about 50% by weight of one or more compounds of the invention, or of total active ingredients (that is to say the compounds of the invention, together with: other substances toxic to arthropods or plant nematodes, synergists, trace elements or stabilizers). The actual compositions employed and their rate of application will be selected to achieve the desired effect(s) by the farmer, livestock producer, medical or veterinary practitioner, pest control operator or other person skilled in the art.

Solid or liquid compositions for application topically to animals, timber, stored products or household goods usually contain from about 0.00005% to about 90%, more particularly from about 0.001% to about 10%, by weight of one or more compounds of the invention. For administration to animals orally or parenterally, including percutaneously solid or liquid compositions, these normally contain from about 0.1% to about 90% by weight of one or more compounds of the invention. Medicated feedstuffs normally contain from about 0.001% to about 3% by weight of one or more compounds of the invention. Concentrates or supplements for mixing with feedstuffs normally contain from about 5% to about 90%, preferably from about 5% to about 50%, by weight of one or more compounds of the invention. Mineral salt licks normally contain from about 0.1% to about 10% by weight of one or more compounds of formula (I) or pesticidally acceptable salts thereof.

Dusts or liquid compositions for application to livestock, goods, premises or outdoor areas may contain from about 0.0001% to about 15%, more especially from about 0.005% to about 2.0%, by weight, of one or more compounds of the invention. Suitable concentrations in treated waters are between about 0.0001 ppm and about 20 ppm, more particularly about 0.001 ppm to about 5.0 ppm. of one or more compounds of the invention, and may be used therapeutically in fish farming with appropriate exposure times. Edible baits may contain from about 0.01% to about 5%, preferably from about 0.01% to about 1.0%, by weight, of one or more compounds of the invention.

When administered to vertebrates parenterally, orally or by percutaneous or other means, the dosage of compounds of the invention, will depend upon the species, age, or health of the vertebrate and upon the nature and degree of its actual or potential infestation by arthropod or helminth pests. A single dose of about 0.1 to about 100 mg, preferably about 2.0 to about 20.0 mg, per kg body weight of the animal or doses of about 0.01 to about 20.0 mg, preferably about 0.1 to about 5.0 mg, per kg body weight of the animal per day, for sustained medication, are generally suitable by oral or parenteral administration. By use of sustained release formulations or devices, the daily doses required over a period of months may be combined and administered to animals on a single occasion.

The following composition EXAMPLES 2A-2M illustrate compositions for use against arthropods, especially mites or insects, or plant nematodes, which comprise, as active ingredient, compounds of the invention, such as those described in preparative examples. The compositions described in EXAMPLES 2A-2M can each be diluted to give a sprayable compositon at concentrations suitable for use in the field. Generic chemical descriptions of the ingredients (for which all of the following percentages are in weight percent), used in the composition EXAMPLES 2A-2M exemplified below, are as follows:

| Trade Name | Chemical Description |
|---|---|
| Ethylan BCP | Nonylphenol ethylene oxide condensate |
| Soprophor | Tristyrylphenol ethylene oxide condensate |
| BSU | |
| Arylan CA | A 70% w/v solution of calcium dodecylbenzenesulfonate |
| Solvesso 150 | Light C₁₀ aromatic solvent |
| Arylan S | Sodium dodecylbenzenesulfonate |
| Darvan NO₂ | Sodium lignosulphonate |
| Celite PF | Synthetic magnesium silicate carrier |
| Sopropon T36 | Sodium salts of polycarboxylic acids |
| Rhodigel 23 | Polysaccharide xanthan gum |
| Bentone 38 | Organic derivative of magnesium montmorillonite |
| Aerosil | Microfine silicon dioxide |

### EXAMPLE 2A

A water soluble concentrate is prepared with the composition as follows:

| | |
|---|---|
| Active ingredient | 7% |
| Ethylan BCP | 10% |
| N-methylpyrrolidone | 83% |

To a solution of Ethylan BCP dissolved in a portion of N-methylpyrrolidone is added the active ingredient with heating and stirring until dissolved. The resulting solution is made up to volume with the remainder of the solvent.

### EXAMPLE 2B

An emulsifiable concentrate (EC) is prepared with the composition as follows:

| Active ingredient | 25% (max) |
|---|---|
| Soprophor BSU | 10% |
| Arylan CA | 5% |
| N-methylpyrrolidone | 50% |
| Solvesso 150 | 10% |

The first three components are dissolved in N-methylpyrrolidone and to this is then added the Solvesso 150 to give the final volume.

### EXAMPLE 2C

A wettable powder (WP) is prepared with the composition as follows:

| | |
|---|---|
| Active ingredient | 40% |
| Arylan S | 2% |
| Darvan NO₂ | 5% |
| Celite PF | 53% |

The ingredients are mixed and ground in a hammer-mill to a powder with a particle size of less than 50 microns.

### EXAMPLE 2D

An aqueous-flowable formulation is prepared with the composition as follows:

Active ingredient 40.00%

| | |
|---|---|
| Active ingredient | 40.00% |
| Ethylan BCP | 1.00% |
| Sopropon T360. | 0.20% |
| Ethylene glycol | 5.00% |
| Rhodigel 230. | 0.15% |
| Water | 53.65% |

The ingredients are intimately mixed and are ground in a bead mill until a mean particle size of less than 3 microns is obtained.

### EXAMPLE 2E

An emulsifiable suspension concentrate is prepared with the composition as follows:

| | |
|---|---|
| Active ingredient | 30.0% |
| Ethylan BCP | 10.0% |
| Bentone 38 | 0.5% |
| Solvesso 150 | 59.5% |

The ingredients are intimately mixed and ground in a beadmill until a mean particle size of less than 3 microns is obtained.

### EXAMPLE 2F

A water dispersible granule is prepared with the composition as follows:

| | |
|---|---|
| Active ingredient | 30% |
| Darvan No 2 | 15% |
| Arylan S | 8% |
| Celite PF | 47% |

The ingredients are mixed, micronized in a fluid-energy mill and then granulated in a rotating pelletizer by spraying with water (up to 10%). The resulting granules are dried in a fluid-bed drier to remove excess water.

### EXAMPLE 2G

A dusting powder is prepared with the composition as follows:

| | |
|---|---|
| Active ingredient | 1 to 10% |
| Talc powder-superfine | 99 to 90% |

The ingredients are intimately mixed and further ground as necessary to achieve a fine powder. This powder may be appplied to a locus of arthropod infestation, for example refuse dumps, stored products or household goods or animals infested by, or at risk of infestation by, arthropods to control the arthropods by oral ingestion. Suitable means for distributing the dusting powder to the locus of arthropod infestation include mechanical blowers, handshakers or livestock self treatment devices.

### EXAMPLE 2H

An edible bait is prepared with the composition as follows:

| | |
|---|---|
| Active ingredient | 0.1 to 1.0% |
| Wheat flour | 80% |
| Molasses | 19.9 to 19% |

The ingredients are intimately mixed and formed as required into a bait form. This edible bait may be distributed at a locus, for example domestic or industrial premises, e.g. kitchens, hospitals or stores, or outdoor areas, infested by arthropods, for example ants, locusts, cockroaches or flies, to control the arthropods by oral ingestion.

### EXAMPLE 2I

A solution formulation is prepared with a composition as follows:

| | |
|---|---|
| Active ingredient | 15% |
| Dimethyl sulfoxide | 85% |

The active ingredient is dissolved in dimethyl sulfoxide with mixing and or heating as required. This solution may be applied percutaneously as a pour-on application to domestic animals infested by arthropods or, after sterilization by filtration through a polytetrafluoroethylene membrane (0.22 micrometer pore size), by parenteral injection, at a rate of application of from 1.2 to 12 ml of solution per 100 kg of animal body weight.

### EXAMPLE 2J

A wettable powder is prepared with the composition as follows:

| | |
|---|---|
| Active ingredient | 50% |
| Ethylan BCP | 5% |
| Aerosil | 5% |
| Celite PF | 40% |

The Ethylan BCP is absorbed onto the Aerosil which is then mixed with the other ingredients and ground in a hammer-mill to give a wettable powder, which may be diluted with water to a concentration of from 0.001% to 2% by weight of the active compound and applied to a locus of infestation by arthropods, for example, dipterous larvae or plant nematodes, by spraying, or to domestic animals infested by, or at risk of infection by arthropods, by spraying or dipping, or by oral administration in drinking water, to control the arthropods.

### EXAMPLE 2K

A slow release bolus composition is formed from granules containing the following components in varying percentages (similar to those described for the previous compositions) depending upon need:

Active ingredient

Density agent

Slow-release agent

Binder

The intimately mixed ingredients are formed into granules which are compressed into a bolus with a specific gravity of 2 or more. This can be administered orally to ruminant domestic animals for retention within the reticulo-rumen to give a continual slow release of active compound over an extended period of time to control infestation of the ruminant domestic animals by arthropods.

### EXAMPLE 2L

A slow release composition in the form of granules, pellets, brickettes or the like can be prepared with compositions as follows:

| | |
|---|---|
| Active ingredient | 0.5 to 25% |
| Polyvinyl chloride | 75 to 99.5% |
| Dioctyl phthalate (plasticizer) | |

The components are blended and then formed into suitable shapes by melt-extrusion or molding. These composition are useful, for example, for addition to standing water or for fabrication into collars or eartags for attachment to domestic animals to control pests by slow release.

### EXAMPLE 2M

A water dispersible granule is prepared with the composition as follows:

| Active ingredient | 85% (max) |
|---|---|
| Polyvinylpyrrolidone | 5% |
| Attapulgite clay | 6% |
| Sodium lauryl sulfate | 2% |
| Glycerine | 2% |

The ingredients are mixed as a 45% slurry with water and wet milled to a particle size of 4 microns, then spray-dried to remove water.

The following representative test method was used, applying the compounds of the invention hereinabove prepared.

The following representative test procedures, using compounds of the invention, were conducted to determine the pesticidal use and activity of compounds of the invention against certain insects and ticks, including aphids and nematodes. The specific species tested were as follows:

Method A: Heliothis virescens Screen

Pieces of filter paper containing about 30, 24-hour-old eggs of the tobacco budworm (Heliothis virescens) were dipped into an aqueous solution of the formulated preparation to be examined for about 5 seconds and subsequently placed into a Petri dish containing filter paper and about 5 ml of culture medium. A further 200 μl of the aqueous solution was dropped onto the culture medium. The Petri dish was closed and kept at 25° C. in a climate chamber. After 6 days storage, the effect of the preparation on the eggs and the larvae which may have hatched was determined.

Method B: Aphis fabae Screen

Germinated field bean seeds (Vicia faba) with roots were transferred into bottles filled with tap water and an aqueous solution of the formulated preparation to be examined (4 ml) was added. The plants were then infested with approximately 100 black bean aphids (Aphis fabae) and stored in a controlled-environment cabinet at 25° C. After 3 and 6 days storage, the effect of the preparation on the aphids was determined.

Method C: Nematode Screen

An aqueous solution of the formulated preparation to be examined (2 ml) was dropped into a glass vessel containing 3000 recently hatched, active (mobile) larvae (2nd development stage) of the root gall nematode (Meloidogyne incognita). After the nematode larvae have been permanently exposed for 2 days, the percentage of the specimen which had been immobilized was determined in comparison with the untreated controls (percent nematicidal contact activity).

Method D: Nephotettix cinciceps Screen

The leaves of 12 rice plants having a stem length of 8 cm were dipped for 5 seconds into an aqueous solution of the formulated preparation to be examined. After the solution had run off, the rice plants treated in this manner were placed in a Petri dish and populated with about 20 larvae (L3 stage) of the rice leafhopper species Nephoteftix cincticeps. The Petri dish was closed and then stored in a climate chamber (16 hours of light/day, 25° C., 40-60% relative atmospheric humidity). After 6 days storage, the mortality among the leafhopper larvae was determined.

Method E: Rhipicephalus sanguineus Screen

A solution of the formulated preparation to be examined was dropped onto filter paper. After solvent evaporation the filter paper was infested with 20-30 tick larvae (Rhipicephalus sanguineus). After 24 hours storage at 25° C. the efficacy of the preparation was determined.

In the above test method A compound numbers 3, 7 and 12 gave at least 50% control at a concentration of 500 ppm or less.

In the above test method B compound number 12 gave at least 50% control at a concentration of 500 ppm or less.

In the above test method C compound numbers 3, 7 and 8 gave at least 50% control at a concentration of 500 ppm or less.

In the above test method D compound number 8 gave at least 50% control at a concentration of 500 ppm or less.

In the above test method E compound number 9 gave at least 50% control at a concentration of 500 ppm or less.

1. A method for the control of pests at a locus, which method comprises applying thereto a pesticidally effective amount of a compound which is a 4-spirocyclic pyrazole of formula (I): 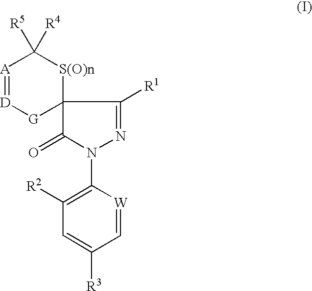
wherein:
R¹ is alkyl, haloalkyl, NH₂, CN, CSNH₂, NO₂ or halogen;
W is N or CR⁶;
R² and R⁶ are each independently hydrogen or halogen;
R³ is hydrogen, halogen, haloalkyl, haloalkoxy, —S(O)ₚCF₃ or SF₅;
A is CR⁷ or N;
D is CR⁸ or N;
G is CR⁹R¹⁰, O, S(O)_{q} or NR¹¹;
R⁴, R⁷, R⁸ and R⁹ are each the same or different hydrogen, alkyl, haloalkyl, alkenyl, haloalkenyl, alkynyl, cycloalkyl, halogen, alkoxy, haloalkoxy, CO₂H, CO₂R¹², CHO, COR¹², CN, OH, OCOR¹³, OSiR¹²R¹⁴R¹⁵, OP(═O)(OR¹²)(OR¹⁴); alkyl substituted by OH, alkoxy or CO₂R¹²; NR¹⁶R¹⁷, NHCOR¹², NHCO₂R¹³, SiR¹²R¹⁴R¹⁵, S(O)ₘR¹², S(O)ᵤR¹³, R¹³ or R¹⁸;
or any two adjacent groups R⁴, R⁵, R⁷, R⁸, R⁹ and R¹⁰ may together with the atoms to which they are attached form a monocyclic, or fused bicyclic ring system, each ring of which is a 4 to 7 membered saturated, partially or fully unsaturated carbocycle or heterocycle, said heterocycle containing from 1 to 3 heteroatoms which may be the same or different selected from O, N and S, which rings may also contain a bridging group X, and each ring being optionally substituted by alkyl, halogen or alkoxy which may be the same or different;
or when G is CR⁹R¹⁰, R⁴ and R⁹ may together form a bridging group X;
X is O, S(O)ᵣ or —(CH₂)ₜNR¹⁹, —(CR²⁰R²¹)ₛ—, —C(═O)O— or —C(═O)NR²²—;
R⁵ and R¹⁰ are each the same or different hydrogen, alkyl, halogen, alkoxy or CO₂R;
R¹¹, R²⁰ and R²¹ are each the same or different hydrogen or alkyl;
R¹², R¹⁴ and R¹⁵ are each the same or different alkyl or haloalkyl;
R¹³ is phenyl optionally substituted by halogen, alkyl, haloalkyl, alkoxy, CN, NO₂ or NR¹⁶R¹⁷;
R¹⁶ and R¹⁷ are each the same or different hydrogen, alkyl or haloalkyl;
R¹⁸ is a three to seven membered heterocyclic ring containing one or more O, N or S atoms, which may be staurated, partially or fully unsaturated, which is optionally substituted by halogen, alkyl, haloalkyl, alkoxy, CN, NO₂ or NR¹⁶R¹⁷;
R¹⁹ and R²² are each the same or different hydrogen, alkyl, COR¹² or CO₂R¹²;
m, n, p, q, r and u are each independently have the values zero, one or two;
s is one, two or three; and
t is zero or one;
or an agriculturally acceptable salt thereof.

2. A method according to claim 1 wherein the locus is an area used, or to be used, for the growing of crops and the said compound is applied thereto at an application rate of from 2 g to 1000 g/ha.

3. A pesticidal composition comprising a compound which is a 4-spirocyclic pyrazole of formula (I) as defined in claim 1 or an agriculturally acceptable salt thereof, in association with an agriculturally acceptable diluent or carrier and/or surface active agent.

4. A compound which is a 4-spirocyclic pyrazole of formula (I) as defined in claim 1 or an agriculturally acceptable salt thereof, with the provisos that:
v) when D is N, G is not O, S(O)_{q} or NR¹¹;
vi) when R² is H, R³ is H, R⁴ is H, R⁵ is H, W is CH, A is C(methyl), D is C(methyl), G is CH₂, and n is 0, 1 or 2, then R¹ is not methyl;
vii) when R¹ is amino, R² is H, R³ is H, R⁴ is H, R⁵ is H, W is CH, A is C(methyl), D is C(methyl), G is CH₂, then n is not 0; and
viii) when R² is H, R³ is H, R⁵ is H, W is CH, A is CH, D is CH, G is CR⁹R¹⁰, R¹⁰ is H, R⁴ and R⁹ together form a bridging group —CH₂—, and n is 0, then R¹ is not methyl.

5. A compound according to claim 4 in which R¹ is alkyl, NH₂ or CN.

6. A compound according to claim 4 in which R² is hydrogen or halogen.

7. A compound according to claim 4 in which W is CR⁶ wherein R⁶ is hydrogen or halogen.

8. A compound according to claim 4 in which R³ is hydrogen, haloalkyl or haloalkoxy.

9. A compound according to claim 4 in which R⁴ and R⁵ are each the same or different hydrogen, alkyl or phenyl.

10. A compound according to claim 4 in which A is CR⁷ wherein R⁷ is hydrogen, alkyl or phenyl.

11. A compound according to claim 4 in which D is CR⁸ wherein R⁸ is hydrogen, alkyl or phenyl.

12. A compound according to any claim 4 in which G is CR⁹R¹⁰ wherein R⁹ is hydrogen, alkyl or phenyl, or OSiR¹²R¹⁴R¹⁵, and R¹⁰ is hydrogen; or when G is CR⁹R¹⁰, R⁴ and R⁹ may together form a bridging group X, wherein X is O or —(CH₂)ₛ— wherein s is 1 or 2.

13. A compound according to claim 4 in which
R¹ is R¹ is alkyl, NH₂ or CN;
R² is hydrogen or halogen;
W is CR⁶ wherein R⁶ is hydrogen or halogen;
R³ is hydrogen, haloalkyl or haloalkoxy;
R⁴ and R⁵ are each the same or different hydrogen, alkyl or phenyl;
A is CR⁷ wherein R⁷ is hydrogen, alkyl or phenyl;
D is CR⁸ wherein R⁸ is hydrogen, alkyl or phenyl; and
G is CR⁹R¹⁰ wherein R⁹ is hydrogen, alkyl or phenyl, or OSiR¹²R¹⁴R¹⁵, and R¹⁰ is hydrogen; or when G is CR⁹R¹⁰, R⁴ and R⁹ may together form a bridging group X, wherein X is —(CH₂)ₛ— wherein s is 1 or 2.

14. A compound according to claim 4 in which:
R¹ is CN; R² is halogen; W is CR⁶ wherein R⁶ is halogen); and R³ is CF₃.

15. A veterinary medicament comprising a compound of the formula (i) according to claim 1.

16. A process for the preparation of a compound of formula (I) as defined in claim 1, which process comprises:
a) where R¹, R², R³, R⁴, R⁵, W, A, D and G are as defined in claim 1 and n is zero, the cycloaddition reaction of a compound of formula (II): 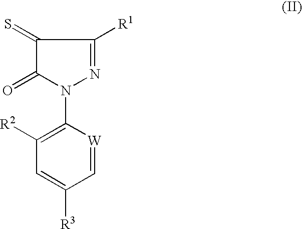
wherein R¹, R², R³ and W are as defined in claim 1, with a diene compound of formula (III): 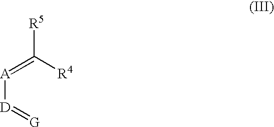
wherein R⁴, R⁵, A, D and G are defined in claim 1; or
b) where R¹, R², R³, R⁴, R⁵, W, A, D and G are as defined in claim 1, and n is zero, treating a compound of formula (V): 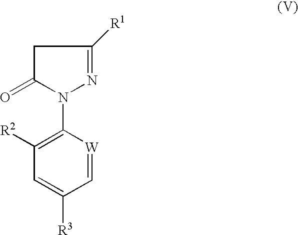
wherein R¹, R², R³ and W are defined above, with a compound of formula (VI): 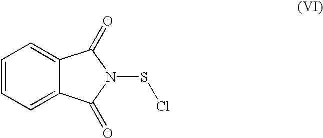
followed by addition of a compound of formula (III) to the resulting reaction mixture, followed by the thermal decomposition of the resulting compound of formula (IV): 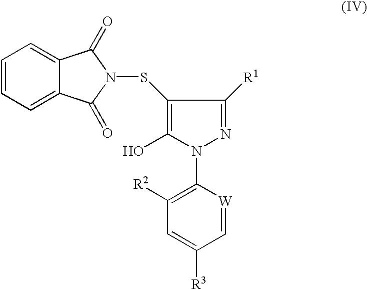
to give a compound of formula (II), which reacts in situ with the compound of formula (III), to give the compound of formula (I); or
c) where R¹, R², R³, R⁴, R⁵, W, A, D and G are as defined in claim 1, and n is 1 or 2, oxidising a corresponding compound of formula (I) in which n is 0 or 1; and
d) if desired, converting a resulting compound of formula (I) into an agriculturally acceptable salt thereof.

17. A compound of formula (II) and (IV), 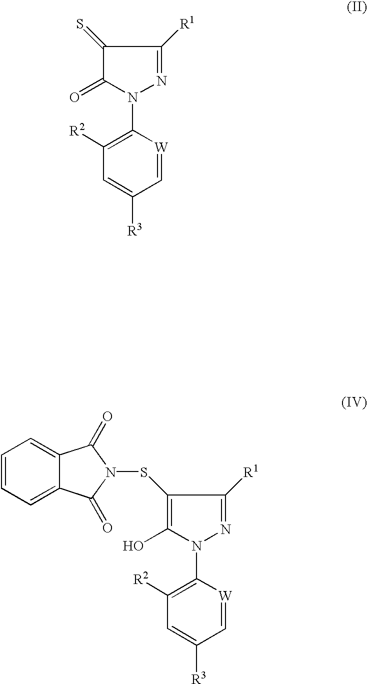
with the proviso that the following compounds are excluded:
3-methyl-1-phenylpyrazolin-5-one-4-thione;
3-amino-1-phenylpyrazolin-5-one-4-thione;
3-methyl-1-phenyl-4-(N-phthalimidosulfenyl)pyrazolin-5-one; and
3-amino-1-phenyl-4-(N-phthalimidosulfenyl)pyrazolin-5-one.
